(19) United States
(12) Patent Application Publication
(10) Pub. No.: US 2009/0201967 A1
(43) Pub. Date: Aug. 13, 2009

(54) LASER DEVICE COMPRISING A DIFFRACTION GRATING AND COUPLED LASER RESONATORS

(75) Inventors: Roman Schnabel, Bad Nenndorf (DE); Oliver Burmeister, Hannover (DE); Alexander Bunkowski, München (DE); Andre Thuring, Winsen (DE); Rolf-Hermann Rinkleff, Garbsen (DE); Karsten Danzmann, Garbsen (DE)

Correspondence Address: GREER, BURNS & CRAIN, 300 S WACKER DR, 25TH FLOOR, CHICAGO, IL, 60606, US

(73) Assignee: LEIBNIZ UNIVERSITAT HANNOVER, Hannover (DE)

(21) Appl. No.: 12/301,331

(22) PCT Filed: May 24, 2006
(86) PCT No.: PCT/EP2006/062626

§ 371 Date: Nov. 18, 2008

(51) Int. Cl. H01S 3/081

(52) U.S. Cl. 372/102

(57) ABSTRACT

The present invention provides a laser device wherein one diffraction grating and at least two reflectors are arranged such that two coupled resonators are formed for the light path. This laser device is an arrangement forming a first optical resonator comprising a first and a second reflector including in its light path the diffraction by the grating. The second reflector is arranged perpendicularly to an order of diffraction of the grating. Coupled with the first resonator (A), there is provided a second mirror-reflective resonator between a mirror-reflective surface of the grating and the second reflector. In the case of the grating having an even number of ports, the second resonator needs completion by a third reflector arranged to reflect light from specular reflection by the grating back to the grating. For gratings having an odd number of ports, the second reflector is arranged in parallel to the grating. The laser medium is preferably arranged between the first reflector and the grating.

The present invention relates to a laser device having a specific arrangement of reflecting surfaces provided by reflectors and a diffraction grating to provide for at least two resonators which are coupled.

The laser device according to the present invention provides a high performance optical resonator system, producing a very narrow distribution of the wave length, preferably combined with a very clean spatial mode structure, that can be generated by the laser device.

### STATE OF THE ART

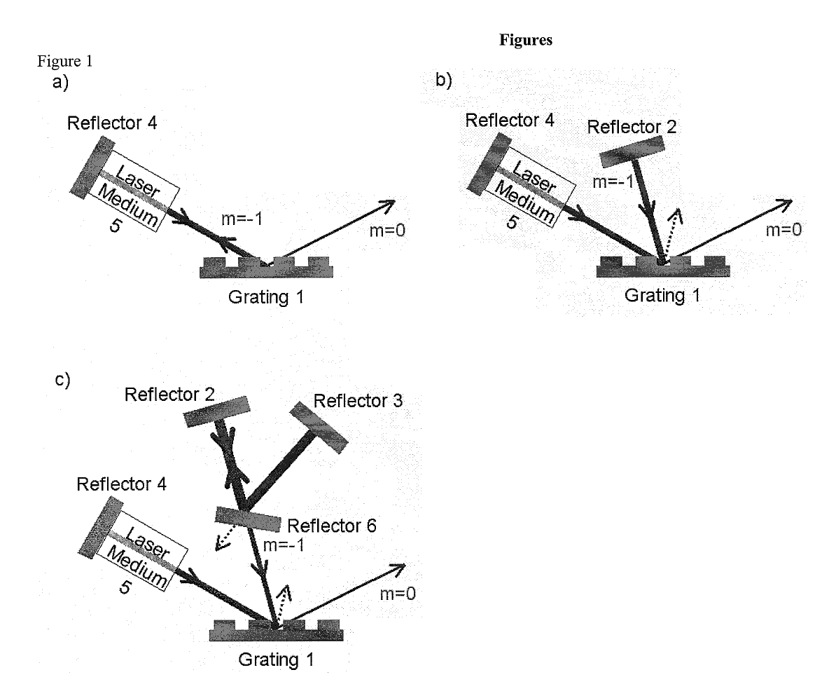

For an overview, FIGS. 1a) to 1c) schematically depict state of art laser devices, namely under a) according to Littrow, under b) according to Littmann, and under c) a grating enhanced external cavity diode laser.

A known laser device was developed by Littrow, wherein the laser medium of a laser is provided with a reflector on one end, arranged perpendicularly within the light path of the emitted light. The opposite end of the light path is directed onto a diffraction grating, also termed refractive grid, having two orders of diffraction, namely m=0 and m=−1 such that the light path extends along the minus first diffraction order m=−1. Accordingly, a resonator is formed between the reflector attached to the laser medium and the diffraction grating along the minus first diffraction order m=−1. Laser light for use is available along the zero diffraction order m=0.

The second commercially used laser device is called Littmann configuration. Equivalent to Littrow, the grating in Littmann also provides two orders of diffraction only. In the field of art, diffraction orders are also termed ports. The zero diffraction order (m=0) is used for the exiting laser beam, whereas the minus first diffraction order (m=−1) is provided with a perpendicularly arranged reflector. A laser medium of a laser is provided on one end surface with a reflector perpendicular to the light path of the laser beam, forming an exiting beam that impinges onto the grating in such a way that its minus first port (m=−1) is not directed back towards the laser medium. Accordingly, a resonator light path is formed between the reflector limiting the minus first diffraction order light path and the reflector limiting the light path of the laser medium, using the diffraction by the grating in the light path between the reflectors. The zero port (m=0) is used as the exit for the laser beam. The Littmann configuration has the advantage over Littrow that the frequency selecting property of the grating is used twice along the resonator light path.

However, a specific a disadvantage of the Littmann arrangement is a loss channel consuming about 50% of the energy in relation to the desired coherent exiting laser light, which loss originates at an angle between the zero diffraction order and the minus first diffraction order.

In the state of art laser devices, a grating having two ports (m=0 and m=−1) at a high refractive efficiency is used in combination with a laser medium, either without an additional reflector (Littrow) and with a reflector (Littmann) for reflecting light diffracted from the grating. The specular reflectivity of the grating, i.e. the reflectivity for which an angle of incidence is equal to the angle of reflection, forms the zero order of diffraction, is not provided with reflectors but used for out-coupling of a laser beam only. Further, the laser medium is always provided with a reflector on one end perpendicular to the laser beam generated, with the opposite end open to direct the primary laser beam to the grating.

The resonators formed by state of art laser devices are only established between the grating and the reflector attached to the laser medium along the second port, presently termed m=−1 of the grating (Littrow), or, alternatively, between the reflector attached to the laser medium and an additional reflector (Littmann), wherein the diffraction by the grating is used to connect the light paths between both reflectors for forming a resonator. Accordingly, in the state of art laser devices, light passes through the laser medium at least once on each cycle using the diffraction by the grating.

In addition to the Littrow and Littmann arrangements, a further laser device is known that establishes two coupled resonators. This grating enhanced external cavity diode laser (Wicht et al., Applied Physics Letters B 137-144 (2004)) arranges one grating having two diffraction orders and a laser medium having a reflector in the same arrangement as Littmann, including its reflector within the light path extending along the minus first diffraction order. However, an additional semi-transparent tilted mirror is arranged within the light path extending along the minus first order diffraction between the grating and the reflector limiting this light path. As the additional reflector is semi-transparent, it allows to form an optical resonator between a further reflector arranged perpendicularly to the light path reflected from the tilted reflector. Accordingly, reflectors 2, 3 and 6 as shown in FIG. 1c) form an external cavity resonator which adds to the quality of the light generated as it forms an additional resonator to the original Littmann resonator generated between reflectors 2 and 4, having a common light path via the grating. This known arrangement has the advantage of providing for two resonators, which are coupled because part of the light paths of both resonators are shared. In state of art devices, laser light for use is provided via the zero diffraction order m=0 of the grating.

For providing an efficient resonator, known laser devices use gratings having a high diffraction efficiency, i.e. >50%. Today, diffraction efficiencies of about 95% are realizable and used in lasers. In state of art laser devices, high efficiency diffraction grating is further necessary for storage of selected light frequencies as well as for diffraction back into the laser medium.

Apart from losses occurring in the known laser devices, which are indicated by dotted arrows in FIGS. 1a to 1c, these known laser devices are disadvantageous in respect of the quality of laser light produced, e.g. the homogeneity of the laser light exiting for use could be improved.

### OBJECTS OF THE INVENTION

In view of known laser devices, offering a variety of arrangements of one to four reflectors around the light paths provided by the one grating having two diffraction orders, the present invention seeks to provide an improved laser device, i.e. providing improved resonator qualities, while preferably using a small number of components.

### GENERAL DESCRIPTION OF THE INVENTION

The present invention achieves the above mentioned objects by providing a laser device having a topology comprising one diffraction grating and at least two mirrors in an arrangement forming two coupled resonators for the light path. This laser device uses a grating having at least two diffraction orders (m=0, m=−1), providing at least two ports along which light paths extend. At least one of the light paths forming a resonator contains a laser medium. In contrast to known laser devices, the present invention uses a grating having a low diffraction efficiency, e.g. below 50%, preferably below 10%, more preferably of or below 1% for all diffraction orders which are m≠0, i.e. for all first, second, third or higher diffraction orders (e.g. m=±1, m=±2, m=±3 etc).

In general, the laser device of the invention can be described as an arrangement forming an optical resonator comprising a first and a second reflector including in its light path the diffraction by the grating, and a mirror-reflective resonator between a mirror-reflective surface of the grating and the second reflector perpendicular to a diffraction order, e.g. the minus first diffraction order, the grating having at least two diffraction orders to provide for coupling of the resonators. The laser medium is preferably arranged between the first reflector and the grating.

Preferably, the laser device comprises a diffractive grating having a high specular reflectivity for all angles of incidence, e.g. above 50%, preferably above 90%, more preferably at or above 99%, respectively, for generating an effective resonator comprising the mirror-reflectivity of the grating and a second reflector.

The laser device according to the present invention comprises a first and a second reflector and a grid comprising at least two ports, with a laser medium of a laser for generating a laser beam arranged in at least one of the light paths between one of the reflectors and the grating, whereby, in contrast to the state of art devices, said laser beam is executing a first resonator cycle from the first reflector to the grating and to a second reflector along the refractivity of the grating, i.e. along a m≠0 order of diffraction, e.g. the minus first order of diffraction, passing the laser medium once on each cycle, and a coupled second resonator extending along the m≠0 order of diffraction, e.g. the minus first order of diffraction of the grating, which resonator is generated by at least one reflector and the reflective surface of the grating. The mirror-reflective second resonator between the reflectivity of the grating and a second reflector can be arranged perpendicular to the grating or in an angle thereto. When the mirror-reflective second resonator is generated to impinge onto the grating in an angle, a third reflector is necessary to complete the resonator, e.g. a third reflector arranged perpendicular to the light path of reflection from the second reflector onto and off the grating. The third reflector is necessary in embodiments wherein the grating has an even number of ports, which third reflector is arranged perpendicularly to the light path mirror-reflected from the grating for mirror-reflecting back towards the grating and the second reflector. In embodiments in which the grating provides an odd number of diffraction orders, the resonator is formed between the second reflector and the reflectivity of the grating, which are arranged in parallel. Accordingly, in embodiments having a grating with an odd number of ports, the angle of incidence from the second reflector onto the grating is 90°, and, accordingly, the angle of reflection is also 90°. Therefore, in these embodiments, the second reflector replaces or includes the third reflector for reflecting the light path of the specular reflection from the grating.

In accordance with the even number of ports of the grating, the laser device in a first embodiment comprises a laser medium, a diffraction grating having an even number of diffraction orders, and a first reflector arranged perpendicularly to a light path in an angle to the grating's normal and a second reflector arranged perpendicularly to a diffraction order of the diffraction grating forming a first optical resonator, characterized by a third reflector arranged perpendicularly to the light path of light reflected from the grating, forming a second reflective optical resonator.

In accordance with the odd number of ports of the grating, the laser device in a second embodiment comprises a laser medium, a diffraction grating, and a first reflector arranged perpendicularly to a light path in an angle to the grating's normal, characterized by the grating having an odd number of diffraction orders, the first reflector arranged perpendicularly to a diffraction order that is different (m=−2) from the central diffraction order (m=−1), and a second reflector (2) arranged parallel to the grating (1).

Both these embodiments realize a laser device that comprises a laser medium (5) in a first optical resonator and a second external optical resonator and a diffraction grating (1), which is part of both the first and the second resonator. As the grating forms part of both the first and second resonators, these resonators are coupled, and one of these resonators, e.g. the second one, is generated by reflective surfaces only, i.e. the grating and the second and third reflectors. In the case of the grating having an odd number of ports, the second reflector is arranged in parallel to the grating and includes the third reflector.

In contrast to the state of art, the present invention therefore provides a laser device including a grating having an essential reflectivity, allowing to establish two resonator light paths, one using the diffraction of the grating and one using the reflective surface of the grating, which resonators are coupled as they share a common section of their light paths.

In the laser device according to the invention, one of the resonators, also termed the second resonator, is generated by reflective surfaces only, resulting in specular reflection, one of which reflective surfaces is provided by the grating order m=0 and the other by at least one reflector. Therefore, in one embodiment, a resonator is formed between at least two reflective surfaces, i.e. the reflectivity of the diffractive grating and a second reflector, both arranged in parallel to one another, or in a further embodiment, a resonator is formed between three reflective surfaces, i.e. the reflectivity of the diffractive grating and two second reflectors that are each arranged perpendicularly to light paths extending in the same angles from reflection off the surface of the grating. In both these arrangements, a laser medium of a laser can be arranged to generate laser light incident in an angle upon the diffractive grating at the point of intersection of its minus first order diffraction, and a first reflector is arranged in the light path of the laser medium opposite to the grating, and a second reflector is arranged perpendicularly to the light path extending along the minus first order of diffraction, forming part of a mirror-reflective resonator with the reflectivity of the grating.

In a first embodiment, the grating has three orders of diffraction with a first reflector arranged perpendicularly to the minus second order of diffraction limiting this light path to the grating, including e.g. the laser medium, and a second reflector is arranged perpendicularly to the minus first order of diffraction, i.e. in parallel to the diffractive grating. Alternatively, the laser medium can be arranged in the minus first order of diffraction, i.e. within the mirror-reflective second resonator formed between the second reflector and the grating, arranged in parallel to one another. This arrangement of reflectors can be used for gratings having a higher odd number of ports, e.g. five, seven or by a multiple of two more ports, as long as the second reflector is arranged in parallel to the grating and, accordingly, perpendicularly to the central order of diffraction originating at 90° of the grating, e.g. perpendicularly to the minus third, minus fifth port, respectively. For gratings having a higher than three odd number of ports, the first reflector can be arranged perpendicularly to any of the remaining ports, optionally arranging the constituent elements of the laser device such that destructive interference minimizes losses by the remaining ports.

In a second embodiment, the grating has an even number of diffraction orders, e.g. two ports, wherein a first reflector limits the light path, which e.g. includes the laser medium, which light path is not directed to extend along a diffraction order of the grating but is arranged to impinge onto the grating at the point of intersection of a m≠0 diffraction order, and a second reflector is arranged perpendicularly to the light path extending along that m≠0 diffraction order. As a consequence, the laser beam exiting the laser medium and reflected by the first reflector impinges in such an angle onto the grating that it is not reflected back along the same light path towards the laser medium but is refracted along an m≠0 diffraction order of the grating. The light path of this m≠0 diffraction order is limited by a second reflector, arranged perpendicular to this m≠0 diffraction order. In accordance with the high reflectivity of the grating, following specular reflection from the second reflector back onto the grating, the light path of the m≠0 diffraction order is mirror-reflected from the grating in the opposite angle off its surface. In order to limit this light path reflected from the grating opposite the m≠0 diffraction order, a third reflector is arranged perpendicularly to the light path originating from specular reflection of the grating. Therefore, in this arrangement, the second and third reflectors also form an optical resonator by reflective surfaces only, including the specular reflectivity of the grating.

The second embodiment is insofar equivalent to the first embodiment as both form an optical resonator generated by reflective surfaces only, i.e. without refractive elements, including the reflectivity of the grating. In the second embodiment, the light path reflected from the second reflector back to the grating is arranged in an angle other than 90° to the grating. As a consequence, the resonator generated by specular reflection of reflective surfaces only for completion uses a third reflector arranged perpendicularly to the light path reflected from the grating.

In the first embodiment, in accordance with the central order of diffraction, the second reflector is arranged in parallel to the grating. As a consequence, the reflective surface of the grating generates a reflected light path that is directed to the same second reflector. Therefore, in the first embodiment, the one second reflector suffices for generating the mirror-reflective optical resonator including the grating, whereas in the second embodiment, the mirror-reflective optical resonator including the grating is established with an additional third reflector.

In the embodiments of the invention, the resonator formed by specular reflection from the reflective surfaces of at least one first reflector and the specular reflection from mirror-reflectivity of the grating is coupled with the light path formed by the first reflector and the grating to the second reflector, in which portion of the light path the laser medium is preferably arranged, using diffraction by the grating between the first and the second reflectors. The light path of the first resonator, generated by the first reflector and the grating is formed such that the first reflector is arranged perpendicularly to the light path incident in an angle to the grating in the area of where the m≠0 diffraction order, e.g. the minus first diffraction order emanates from the grating, and by a second reflector that is arranged perpendicularly to the m≠0 diffraction order, e.g. the minus first order of diffraction for mirror-reflecting onto the grating.

Accordingly, when a grating having two orders of diffraction is used, the second reflector perpendicular to the m≠0 diffraction order, e.g. the minus first order of diffraction mirror-reflects along the same order of diffraction, and due to the efficient reflectivity of the grating generates a light path opposite in the same angle by reflecting from the mirror reflectivity of the grating. In this embodiment, as in cases using a grating having an even number of diffraction orders, a third reflector is arranged perpendicularly to the light path mirror-reflected from the grating, establishing an optical resonator using reflective surfaces only. A minor portion of the light reflected from the second reflector along the m≠0 diffraction order, e.g. the minus first order port onto the grating is diffracted into the light path between the grating and the first reflector. Accordingly, the light path extends between the first reflector to the second reflector along the diffraction by the grating, forming a resonator between the first and the second reflector. As a consequence, this resonator shares the distance between the grating and the second reflector with the resonator formed by the mirror-reflectivity of the grating and of the second and third reflectors, resulting in the coupling of both resonators.

As the optical resonator between the grating and at least the second reflector is coupled with the light path between the first mirror and the grating, the remaining ports, e.g. the zero diffraction order like the reflection port of the first reflector, receive light in dependence on the proportion of destructive interference between the first and second resonators.

The laser device according to the invention for the first time provides the use of the reflective surface of a grating for generating an optical resonator established by specular reflection from reflective surfaces only in a laser device. Due to the coupling of this resonator formed by reflective surfaces only with a resonator using the diffraction of the grating, this laser device is specifically advantageous in generating highly coherent laser light. It is especially advantageous to arrange the laser medium within the resonator established using the diffraction of the grating, i.e. between the first reflector and the grating in order not to arrange a laser medium in the second resonator, as this could limit the generation of highly coherent laser light in this resonator. Further, arrangement of the laser medium within the light path between the first reflector and the grating serves to avoid the formation of thermal lenses such that the purely reflective resonator comprising the reflective surface of the grating can store highly coherent light at high energy.

In a specifically preferred embodiment, the laser device according to the invention has an odd number of diffraction orders, preferably three or five ports. When using a grating having an odd number of diffraction orders, the diffraction orders are symmetrically arranged around the central diffraction order forming an axis of symmetry therein, which in the case of three diffraction orders is the minus first port m=−1, and in the case of five diffraction orders is the minus second port m=−2. In this embodiment, the central diffraction order is arranged perpendicular to the grating and, accordingly, the second reflector forming a resonating light path extending along the central diffraction order is arranged in parallel to the grating, i.e. perpendicular to the central diffraction order to the odd number of ports. As a consequence, the grating is preferably provided with a highly reflective surface, which is e.g. arranged on its surface distant or opposite to the second reflector, forming a resonator between the grating and the second reflector between two reflective surfaces only.

In this preferred embodiment, one resonator is formed between two reflector surfaces, i.e. between the grating, using its reflectivity, and the first reflector arranged perpendicular to the central diffraction order corresponding to the axis of symmetry to the odd number of diffraction orders. As a consequence, a highly effective optical resonator is formed between the two reflective surfaces, namely between the first reflector and the reflective surface of the grating, allowing for a very efficient resonator and a high storage capacity of laser light.

In accordance with the high number of cycles performed by the irradiation within the optical resonators, it has been found that the laser device of the invention allows to generate laser irradiation having very low mode fluctuations.

For applications in need of high energy laser beams, it is preferred to arrange the laser medium within the light path corresponding to the optical order forming the axis of symmetry of a grating having an odd number of diffraction orders, i.e. within the central diffraction order.

Laser light for use can exit via at least one of the first and/or second and/or third reflectors or the grating, at least one of which has some transmittance. Alternatively, laser light can be out-coupled along the light path corresponding to a diffraction order other than the diffraction order along which the first resonator between the grating and the first reflector is generated, or other than the diffraction order along which the second resonator between the grating and the second reflector, and a third reflector in the case of an even number of ports, is generated. For example, in the case of the grating having three optical orders, laser light can exit via the light path extending along the zero order diffraction, m=0. Although less preferred, the reflective surface of the grating can be provided with some transparency, allowing laser light to exit opposite to the second reflector.

The arrangement of the first reflector and the second reflector to provide for two optical resonators with the grating each, in combination with the coupling of both resonators, allows to generate highly coherent laser irradiation. Due to the high reflectivity of the second reflector and of the grating, laser light is reflected many times between the second reflector and the grating. The spacing of the grating and the second reflector determines the frequency at which the light constructively interferes with itself. In this way, the irradiation having the desired frequency is stored between the first reflector and the grating and, due to the coupling with the resonator formed between the grating and the second reflector, this irradiation is boosted within the laser medium. This effect of the laser device according to the invention is especially true for the preferred embodiments, wherein the grating provides two or three ports.

In all embodiments of the invention, the storage time and, accordingly, the quality of especially the second reflective resonator is high and the grating's diffraction efficiency are adjustable such that destructive interference occurring in all ports that do not contain a reflector arranged perpendicularly to them can be increased practically at will, e.g. to the theoretical limit which is allowable by the optical quality of the components used. In the case of the grating having three diffraction orders, the destructive interference in the zero order diffraction m=0 can be adjusted to practically eliminate exiting laser light. As a result, loss irradiation is greatly reduced.

A laser beam for use in technical applications or for measurements can be out-coupled from the laser device by at least one of the first reflector and the second reflector or the grating having partial transmittance. Alternatively, the diffraction efficiencies of the grating can be generated such that the destructive interference on the port having a lower or higher nominal order than the diffraction order along which the first resonator extends, e.g. m=0 in the case of a three-port grating, is not complete, and, accordingly, a laser beam can be out-coupled via this port.

Applications of the laser device according to the invention comprise technical applications that utilize the energy of the laser beam, e.g. in cutting or welding, wherein the laser device is advantageous in not requiring any transmissive optical components, as well as its high energy storage capacity in combination with the avoidance of irradiation loss.

Applications of the laser device also include the transmission of information, as the laser device of the invention generates a laser beam having very low mode fluctuations.

Further applications also include measurement, because the symmetric arrangement of diffraction orders allows to detect interactions of at least two ports, because at least one remaining port can be used for observing an effect caused by an alteration to the interaction of the resonators formed between the grating and the first reflector and between the grating and the second reflector, respectively. An exemplary interaction to cause such an alteration are e.g. interfering waves or movements of reflectors. When e.g. using a grating providing three diffraction orders, an alteration of the destructive interference in the zero diffraction order (m=0) can be observed, caused by the two resonators extending in the minus first diffraction order and the minus second diffraction order, respectively.

### DETAILED DESCRIPTION OF THE INVENTION

The present invention is described in greater detail with reference to the figures, wherein

FIG. 1a) schematically shows a laser device known in the state of art according to Littrow,

FIG. 1b) schematically shows a laser device of the state of art according to Littmann,

FIG. 1c) schematically shows the laser device according to Wicht et al. (loc. cit.) of the state of art,

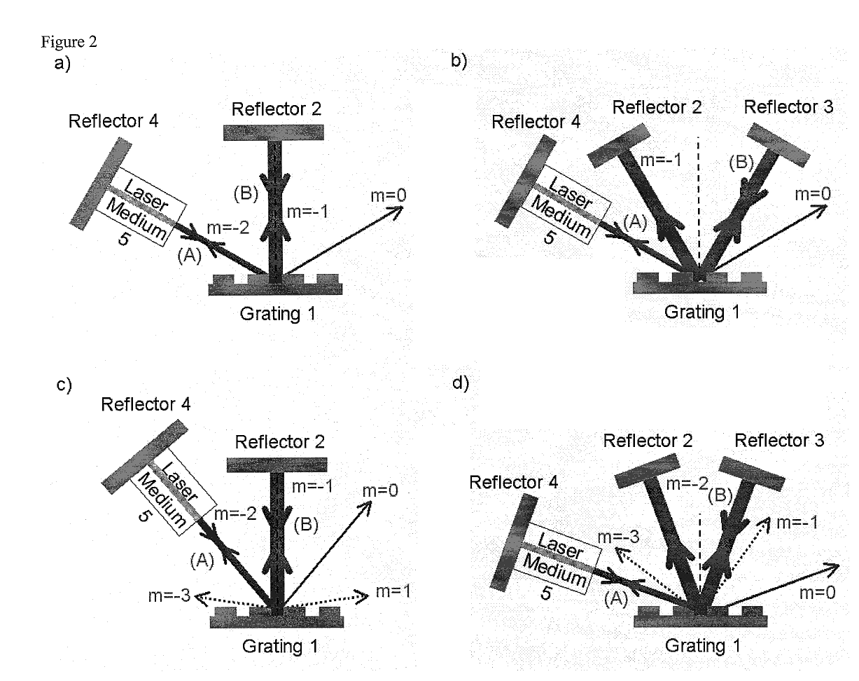

FIGS. 2a) and c) schematically show laser devices according to the invention using a grating having a diffraction order oriented perpendicular to the grating's surface, and

FIGS. 2b) and d) schematically show laser devices according to the invention using a grating having an even number of diffraction orders, and, accordingly, no diffraction order oriented perpendicular to the grating's surface.

In the figures, presumed optical resonators are indicated by oppositely directed arrowheads, and presumed loss channels are indicated by dotted lines. As one possibility for outcoupling laser irradiation, the m=0 port is drawn as a thin arrow.

A preferred first embodiment of the laser device of the present invention is schematically depicted in FIG. 2a), wherein the grating 1 has three diffraction orders providing for corresponding three ports, namely m=0, m=−1 and m=−2. Therefore, the minus first diffraction order m=−1 provides for a port, along which a light path is generated extending perpendicular to the surface of the grating 1. The laser medium 5 is arranged in the minus second port m=−2, establishing a first refractive resonator (A) between grating 1 and first reflector 4, arranged perpendicular to the minus second order port. The second reflector 2 is arranged in parallel to grating 1 and spaced from grating 1, corresponding to an arrangement perpendicular to the central port m=−1, establishing second reflective resonator (B) with the reflectivity of grating 1. The resonator (B), created between grating 1 and second reflector 2 is coupled with resonator (A), which is generated extending along the minus second diffraction order m=−2 of grating 1.

The zero diffraction order m=0 is indicated as a thin arrow, indicating that along diffraction order m=0, light passes only if the destructive interference of coupled first (A) and second (B) resonators is not total.

The degree of the destructive interference of first (A) and second (B) resonators can be adjusted by varying the spacing between one of first reflectors 4 and grating 1 or second reflector 2 and grating 1, preferably by varying the spacing between second reflector 2 and grating 1. Furthermore, a variation of the spacing between grating 1 and second reflector 2 will influence the wavelength of the light within the resonator (B) and, accordingly, the colour of the laser light exiting via the zero diffraction order m=0 is adjustable thereby.

In a specific embodiment, the laser medium 5 is arranged within the light path of resonator (A), corresponding to the minus first diffraction order between the grating 1 and second reflector 2. In this arrangement, it is advantageous that the laser medium 5 is arranged within the one of the two resonators (B) and (A) that collects and builds up a less intense radiation, e.g. between the respective first reflector 4 and the grating 1, as the generation of thermal lenses is reduced or avoided in this path. Therefore, the arrangement of the laser medium 4 within the minus second diffraction order light path (A) is preferred for laser applications in need of very high coherence of the laser beam generated.

In the alternative, the laser medium 5 can be arranged within resonator (B), generated between grating 1 and the second reflector 2, which are preferably arranged in parallel to one another and perpendicular to the diffraction order within which they are arranged, e.g. the minus first diffraction order in the case of a three port grating 1. This arrangement (not shown) of the laser medium 5 is especially preferred for applications in need of very high energy laser beams, because high power laser radiation can be coupled out with an all-reflective, shallow grating structure.

In both arrangements of the laser medium 5, i.e. within resonator (B) or resonator (A), the coherence of the light within the light path corresponding to a diffraction order of the grating 1 can be enhanced and the coupling between the first and second resonators improved by arranging one or more collimating lenses and/or one or more steering mirrors within the resonator light path within which the laser medium 5 is arranged.

The first and second reflectors, e.g. reflectors 4 and/or 2, may be planar or concave or convex or of any free form if an enhancement of the coherence of the reflected light and reduction of loss is desired. The grating can be planar or concave or convex.

The laser medium 5 may be provided in the form of a laser diode, one side of which is provided with a planar or concave reflective surface as a first reflector 4 perpendicular to the direction of the laser beam emitted.

It is a specific advantage of the laser device according to the present invention, especially in its embodiments using the grating providing two or three diffraction orders, i.e. two or three ports, that no loss channels are formed, resulting in a high efficiency for the conversion of energy introduced into the laser medium to a coherent laser beam.

It is preferred that first and second reflectors 4 and 2 provide for a high efficiency of reflectivity, i.e. at or above 99.9%. The specular reflectivity of the grating 1 is preferably at least 50%, more preferably at least 90% or 99%, most preferably at least 99.9% when using e.g. a port having a nominally lower diffraction order than the central port forming the resonator (B), e.g. port m=0, for the exiting laser beam in the case of a two-port or three-port grating 1. Alternatively, one of the first and second reflectors 4 and 2 and/or grating 1 may have some transmittance, i.e. a lower reflectivity than 99.9% for allowing the transmission of a laser beam from one of the resonators, preferably of resonator (A), either through first reflector 4 or grating 1. In the latter embodiment, the spacing of second reflector 2 to grating 1 is preferably adjusted such that destructive interference eliminates loss irradiation via the zero diffraction order m=0.

FIG. 2c) schematically depicts a laser device having a grating 1 that provides five ports. Therein, the second reflective resonator (B) extends along central port m=−1, which is limited by the second reflector 2. A third reflector is not necessary, as the central port is oriented perpendicularly to the grating and, as a consequence, the specular reflection from the grating 1 extends along the central port as well. Preferably, the first reflector 4 is arranged perpendicularly to port m=−2, with the laser medium arranged within the latter. In order to minimize losses, ports m=1, 0, and −3 can be closed by destructive interference. For outcoupling of laser radiation, destructive interference can be incomplete along one of ports m=1, 0, and/or −3.

An embodiment comprising a grating 1 having an even number of diffraction orders is shown in FIG. 2b), wherein the grating 1 has two ports. The laser medium 5 is arranged such that its exiting laser beam impinges onto the grating 1, which is diffracted to extend along port m=−1, generating a first refractive resonator (A) between the first reflector 4, arranged perpendicularly to the light path of the laser beam exiting the laser medium to reflect the laser medium onto grating 1 and second reflector 2, arranged perpendicularly to port m=−1.

Due to the high reflectivity of grating 1, the light reflected from second reflector 2 is reflected in the opposite symmetrical angle, corresponding to a port m=0 with respect to second reflector 2. This light path formed by reflection by grating 1 of light reflected from second reflector 2, is reflected by third reflector 3, forming a second reflective resonator (B) with the reflective surface of grating 1.

As indicated by the thin arrow along the port m=0, a port having a lower nominal number than the port establishing the second resonator (B), e.g. port m=−1 in this example, can be used for outcoupling laser irradiation.

FIG. 2d) schematically depicts a laser device having a grating with 4 ports. In this embodiment, the first reflector 4 is arranged to reflect the laser beam of the laser medium 5 in an angle onto the grating 1 such that it can form a refractive resonator with the second reflector 2, which is arranged perpendicularly to the minus second port m=−2. The light path formed by reflection from second reflector 2 onto the grating 1, due to the high specular reflectivity of the grating 1, is reflected symmetrically. The path of this symmetrically reflected light of grating 1 is limited by third reflector 3, forming second resonator (B) by specular reflection only.

As can be seen from the schematic drawings of FIG. 2, the laser devices of the invention share the generation of a first refractive resonator (A) and a second specular resonator (B), which resonators (A, B) are coupled, employing a grating 1 having an even or odd number of ports. Owing to the central port of gratings 1 having an odd number of ports, in these embodiments the second reflector 2 suffices for generating the specular optical resonator (B). In embodiments comprising a grating 1 having an even number of ports, the reflection by grating 1 does not use the light path between the second reflector 2 and the grating but generates an opposite light path, e.g. opposite the m=−2 port. Accordingly, in these embodiments, a third reflector 3 is needed to limit the light path originating from specular reflection by the grating 1.

### EXAMPLE

### Infrared Laser Device

The laser device of the invention can be realized in an arrangement of components according to FIG. 2a) with the following details: The laser medium is a laser diode (model SAL-1060-060, obtained from Sacher Lasertechnik, Marburg), emitting in the range of 1060 nm at a power of 60 mW. First reflector 4 is arranged in an angle of 47.2° degrees against the grating's normal, second reflector 2 is arranged in parallel to the grating surface. Both first and second reflectors are spaced at a distance of 5 cm to the grating. Additionally, a collimating lense could be placed between the laser diode and the grating.

The grating has three ports, generated by a grid structure on its surface having a binary structure with a height of 150 nm at a period of 1450 nm. The reflective surface of the grating is arranged on top of its grid structure. The reflective surface is positioned opposite to the second reflector and coated by subsequent layers of SiO₂ and Ta₂O₅ to provide for a high reflectivity (99.97%).

1. Laser device comprising a laser medium, a diffraction grating, and a first reflector arranged perpendicularly to a first light path in an angle to the grating's normal, and a second reflector arranged perpendicularly to a diffraction order of the diffraction grating forming a first optical resonator (A) with the first reflector, characterized by the second reflector and a third reflector arranged perpendicularly to the light path of light reflected from the grating, forming a second reflective optical resonator (B).

2. Laser device according to claim 1, characterized by the grating having an odd number of diffraction orders and the third reflector being replaced by the second reflector, which is arranged in parallel to the grating.

3. Laser device according to claim 1, characterized in that the diffraction grating has a reflectivity above 50%.

4. Laser device according to claim 1, characterized in that the grating is provided with a reflective surface covering its grid structure, which reflective surface is oriented towards the second reflector.

5. Laser device according to claim 1, characterized in that the laser medium is arranged in the light path between the first reflector and the grating.

6. Laser device according to claim 1, characterized in that one of the first reflector, second reflector and grating has a partial transmittance.

7. Laser device according to claim 1, characterized in that the reflectivity of the first reflector, and the second reflector is at least 99.9%, and destructive interference towards the first diffraction order (m=0) is not total.

8. Laser device according to claim 1, characterized in that the laser medium is a laser diode.

9. Laser device according to claim 1, characterized in that at least one of the first or second reflectors is concave.

10. Laser device according to claim 1, characterized in that a collimating lens and/or at least one steering mirror is arranged in the light path extending between the first reflector and the grating.
